(19) United States
(12) Patent Application Publication
(10) Pub. No.: US 2005/0099806 A1
(43) Pub. Date: May 12, 2005

(54) Direct type backlight module

(76) Inventor: Yi-Shiuan Tsai, Kaohsiung City (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/845,020

(22) Filed: May 13, 2004

(30) Foreign Application Priority Data
Nov. 10, 2003 (TW) 092131441

(51) Int. Cl. F21V 7/20; F21V 29/00

(52) U.S. Cl. 362/218; 362/345; 362/294

(57) ABSTRACT

A direct type backlight module with better light source utilization and with heat-radiation performance is provided. The direct type backlight module includes a light source, a bazel and a reflecting sheet. The light source is disposed inside the bazel which includes at lease one run-through hole, while the reflecting sheet is disposed on the bazel for masking the run-through hole thereof. Of which, the heat generated by the light source is dissipated outside the bazel through the heat-dissipating hole of the reflecting sheet and through the run-through holes of the bazel in succession.

This application claims the benefit of Taiwan application Serial No. 092131441, filed Nov. 10, 2003, the subject matter of which is incorporated herein by reference.

### BACKGROUND OF THE INVENTION

1. Field of the Invention

The invention relates in general to a direct type backlight module, and more particularly to a direct type backlight module with a better utilization rate of the light source and with a better heat radiation performance.

2. Description of the Related Art

Along with the booming growth in the industry of liquid crystal display (LCD), new products which are lighter and slimmer are continually brought forth to the market and a large variety of LCD products are applied in wider dimensions. Since LCD panel is not self-luminous, the LCD still needs a backlight module to provide necessary light for display purpose.

Generally speaking, the backlight module can be classified as the side type backlight module and the direct type backlight module according to where the light source is positioned. The side type backlight module has the light source installed at the lateral sides in an attempt to reduce the thickness and is normally used in portable electronic produces like mobile phone, PDA, etc. The direct type backlight module has the light source installed under the LCD panel in an attempt to produce a better luminance for the LCD panel and is normally used in desk-top computer and TV where a high luminance display monitor is required.

Referring to FIG. 1A, a sectional view of a conventional direct type backlight module is shown. In FIG. 1A, direct type backlight module 10 includes a bazel 11, a reflective plate 12, plural light sources 13 and a diffuser plate 14. The light source 13 can be a cold cathode fluorescent lamp (CCFL); the reflecting plate 12 is adhered onto the slot bottom 11b and the two slot walls 11c of the accommodation slot 11a; the CCFL 13 is disposed at the accommodation slot 11a in parallel and are positioned above the reflective plate 12. Of which, the reflective plate 12 is for reflecting the light emitted by the CCFL 13, while the diffuser plate 14, which is disposed above the CCFL 13, is for evenly diffusing the light emitted by the CCFL 13 onto the LCD panel.

When the CCFL 13 emits light, heat will be generated. Since the bazel 11 of the direct type backlight module 10 is normally an enclosed region, heat will build up at the accommodation slot 11a. This will cause an increase in the temperature of the direct type backlight module 10, thereby affecting the luminance quality of the direct type backlight module 10. Normally, plural holes 15 are formed on the bazel 11 and on the reflective plate 12 which are located on the slot bottom 11b of the accommodation slot 11a. The disposition of the holes 15 corresponds to the CCFL 13 to facilitate the ventilation of the air, so that the heat generated inside the direct type backlight module 10 can be dissipated outside the bazel 11 and the temperature inside can be reduced.

There are two manufacturing methods for the reflective plate 12: one is to apply a coating of reflecting material on the bazel 11, the other is to adhere a reflecting film onto the bazel 11. When plural run-through holes 15 are formed on the reflective plate 12, a restriction due to the material factor of reflective plate 12 arises, i.e., D, the diameter of the hole 15, must be two times larger than T, the thickness of the reflective plate 12, as shown in FIG. 1B, an enlargement of part B in FIG. 1A. Under this circumstance, the large diameter of the holes 15 will cause the light to leak out through the holes 15, thereby reducing the utilization rate of the light.

### SUMMARY OF THE INVENTION

It is therefore an object of the invention to provide a direct type backlight module with a better utilization rate of the light source and with a better heat radiation performance.

According to the object of the invention, a direct type backlight module including a bazel, a reflecting sheet and a light source is provided. An accommodation slot is formed inside the bazel, while at least one run-through hole which connects the accommodation slot to the outside is formed on the bazel. Plural heat-dissipating holes are formed on the reflecting sheet which is disposed on the surface of the accommodation slot inside the bazel for masking the run-through hole of the bazel. The light source is disposed inside the accommodation slot, wherein the heat generated by the light source is ventilated outside the bazel through the heat-dissipating holes of the reflecting sheet and through the run-through holes of the bazel in succession.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1A is a partial sectional view of a conventional direct type backlight module;

FIG. 1B is an enlargement of part B in FIG. 1A;

FIG. 2 is a partial sectional view of a direct type backlight module according to a preferred embodiment of the invention; and

FIG. 3 is a partial sectional view of another direct type backlight module according to a preferred embodiment of the invention.

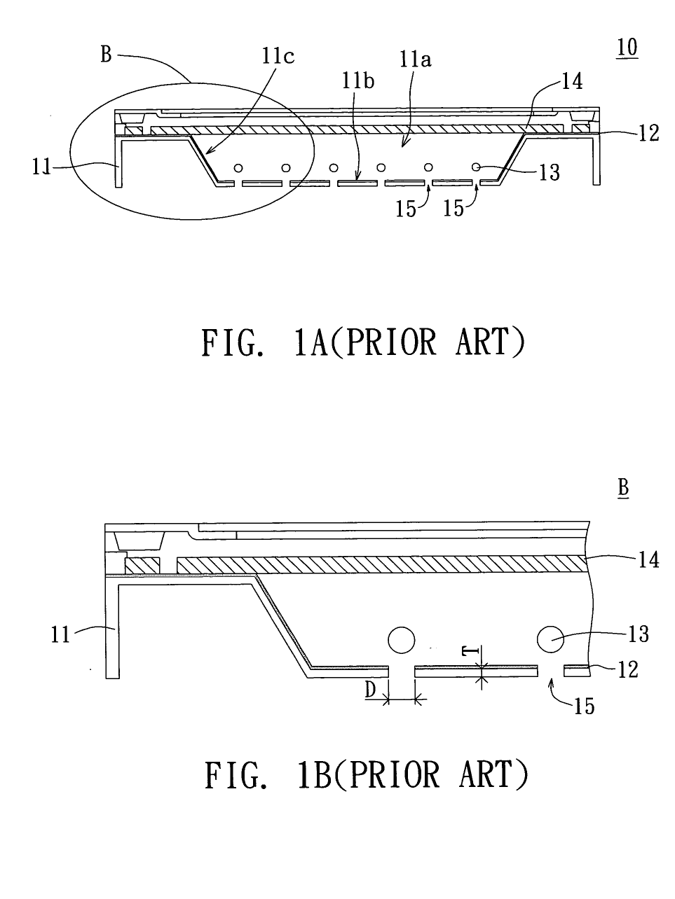

### DETAILED DESCRIPTION OF THE INVENTION

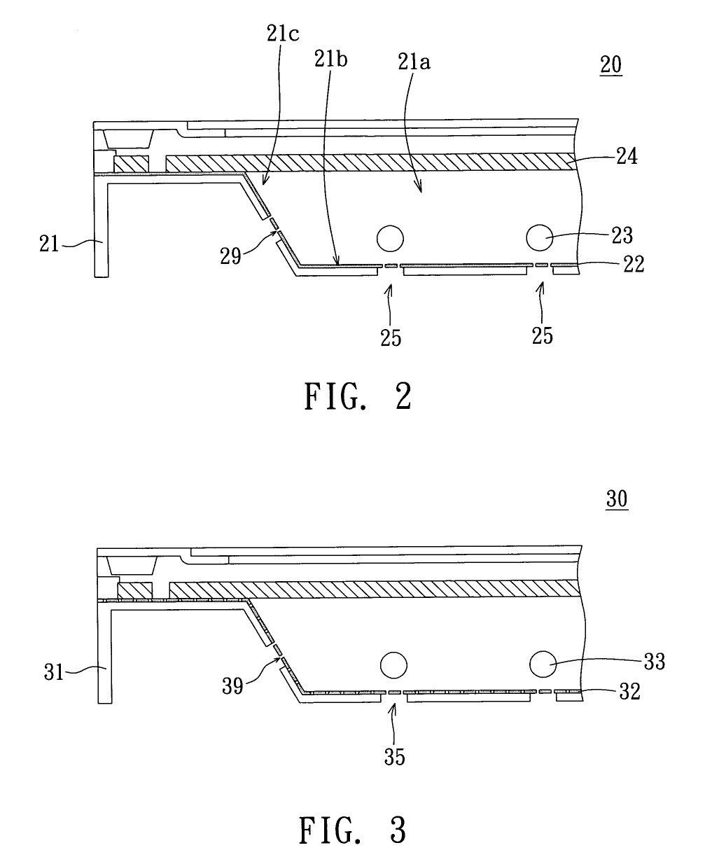

Referring first to FIG. 2, a partial sectional view of a direct type backlight module according to a preferred embodiment of the invention is shown. In the preferred embodiment as shown in FIG. 2, direct type backlight module* 20 includes a bazel 21, a reflecting sheet 22 and plural light source 23. An accommodation slot 21a is formed inside the bazel 21; at least one run-through hole 25 which connects the accommodation slot to the outside is formed on the bazel 21. The run-through holes 25 are preferred to be rectangular and arranged in parallel and are preferred to physically correspond to the light source 25. However, the run-through holes according to the invention are not limited thereto. The shape, the size and the disposition of the run-through holes can be adjusted according to actual considerations as long as the structural strength of the bazel 21 is maintained within an acceptable range and a better heat radiation performance can be achieved.

The reflecting sheet 22 is disposed on the surface of the accommodation slot 21a inside the bazel 21 for masking the run-through holes 25 of the bazel 21 and for reflecting the light emitted by the light source 23. The reflecting sheet 22 can be adhered onto the slot bottom 21b and the two slot walls 21c of the accommodation slot 21a but not limited to which side of the slot bottom 21b. That is to say, the reflecting sheet 22 can be adhered onto either the inner walls or the outer walls of the accommodation slot 21a. The reflecting sheet 22 can be obtained by using a reflective thin sheet during further forming process to form plural heat-dissipating holes thereon. Compared with the conventional method, the above forming process of the invention can produce smaller holes whose diameter ranges from 0.15 mm to 2 mm or even smaller. Furthermore, the heat-dissipating holes 29 formed according to the above forming process are preferably intensively disposed around the run-through holes 25 and the run-through holes 25 are preferably disposed in an arrangement corresponding to the light source 23 as shown in FIG. 2.

The light source 23, which can be of plural cold cathode fluorescent lamps (CCFL) for example, is disposed inside the accommodation slot 21a of the bazel 21 such that the heat generated by the light source 23 can be ventilated outside the bazel 21 through the heat-dissipating holes 29 of the reflecting sheet 22 and through the run-through holes 25 of the bazel 21 in succession. The CCFL 23 can be parallelly disposed in the accommodation slot but above the reflecting sheet 22. Besides, a diffuser plate 24 is disposed above the light source 23 for evenly diffusing the light emitted by the CCFL 13 onto the LCD panel.

It is noteworthy that the heat-dissipating holes 29 of the reflecting sheet 22 according to the preferred embodiment is described in a centered distribution corresponding to the run-through holes 25, however, the invention is not limited thereto. The heat-dissipating holes 29 of the reflecting sheet 22 can also be disposed according to an even or a random distribution.

According to the invention, the diameter of the heat-dissipating holes 29 is designed to be smaller than that of the run-through holes 23 so as to effective stop the light from leaking out. Consequently, the light leakage can be effectively reduced and the light source utilization rate of the CCFL 13 can be further improved. Meanwhile, the air inside the accommodation slot 21a of the direct type backlight module 20 can be ventilated through heat-dissipating holes 29 and run-through holes 25, such that the heat generated by light source 23 when emitting the light can be dissipated outside bazel 21 through heat-dissipating hole 29 and through run-through holes 25 in succession. Since the heat built up inside the direct type backlight module 20 can be dissipated outside, the luminance quality of the direct type backlight module 20 can be further improved.

Referring to FIG. 3, a partial sectional view of another direct type backlight module according to a preferred embodiment of the invention is shown. The direct type backlight module 30 in FIG. 3 is similar to the direct type backlight module 20 in FIG. 2 except for the manufacturing method for the reflecting sheet. The direct type backlight module 30 uses a porous reflecting film as a reflecting sheet 32 to be directly adhered onto the bazel 31 for masking the run-through holes 35 of the bazel 31. The reflecting sheet 32 which is made of porous reflecting film has plural heat-dissipating holes 39 distributed thereon for ventilating the air inside the direct type backlight module 30, so that the heat generated by light source 33 when emitting the light can be dissipated outside the bazel 31 through the heat-dissipating holes 39 of the reflecting sheet 32 and through the run-through holes 35 of the bazel 31 in succession. Consequently, the heat built up inside the direct type backlight module 30 is dissipated outside, the light source utilization rate and the luminance quality is improved.

Moreover, the spirit of the invention is not limited to the above described CCFL light source. That is to say, the design of having run-through holes on the bazel and having heat-dissipating holes on the reflecting sheet in a direct type backlight module can be applied in a CCFL light source as well as in a plane light source to improve the heat radiation performance.

The direct type backlight module disclosed in the above preferred embodiment according to the invention uses a reflecting sheet to mask the run-through holes of the bazel so that the heat generated by the light source can be dissipated outside the bazel through the heat-dissipating holes of the reflecting sheet and through the run-through holes of the bazel in succession Compared with the conventional direct type backlight module 10, the direct type backlight module 20 according to the invention produces a better heat-radiation performance which is at least 5° C. lower than the direct type backlight module 10. On the other hand, the reflecting sheet 22 masks the run-through holes 25 and has smaller heat-dissipating holes 29, so that the light will not be easily leaked out through the heat-dissipating holes 29 and that the utilization rate of the light source 23 can be further improved. By doing so, the invention improves the light source utilization rate and heat-radiation performance of the direct type backlight module, meanwhile, the luminance quality of the direct type backlight module can also be improved.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A direct type backlight module, comprising:
a bazel with an accommodation slot being formed inside, while at least one run-through hole which connects the accommodation slot to the outside is formed on the bazel;
a reflecting sheet, which has plural heat-dissipating holes and which is disposed on the surface of the accommodation slot inside the bazel for masking the run-through hole of the bazel; and
a light source which is disposed inside the accommodation slot, wherein the heat generated by the light source is ventilated outside the bazel through the heat-dissipating holes of the reflecting sheet and through the run-through holes of the bazel in succession.

2. The direct type backlight module according to claim 1, wherein the disposition of the run-through hole physically corresponds to the light source.

3. The direct type backlight module according to claim 1, wherein the run-through hole is in the shape of a rectangle.

4. The direct type backlight module according to claim 1, wherein the heat-dissipating holes of the reflecting sheet are intensively disposed around the light source.

5. The direct type backlight module according to claim 1, wherein the heat-dissipating holes of the reflecting sheet are intensively disposed around the run-through hole.

6. The direct type backlight module according to claim 1, wherein these heat-dissipating holes of the reflecting sheet are evenly distributed.

7. The direct type backlight module according to claim 1, wherein these heat-dissipating holes of the reflecting sheet are randomly distributed.

8. The direct type backlight module according to claim 1, wherein the reflecting sheet is made of a porous reflecting film.

9. The direct type backlight module according to claim 1, wherein these heat-dissipating holes are formed on a reflective thin plate to form the reflecting sheet.

10. The direct type backlight module according to claim 1, wherein the diameter of these heat-dissipating holes ranges from 0.15 mm to 2 mm.

11. The direct type backlight module according to claim 1, wherein the light source is a cold cathode fluorescent lamp.

12. The direct type backlight module according to claim 1, wherein the light source is a plane light source.
